(19) United States
(12) Patent Application Publication
(10) Pub. No.: US 2009/0060162 A1
(43) Pub. Date: Mar. 5, 2009

(54) METHOD AND SYSTEM FOR PROVIDING SECRETARY SERVICES THROUGH A COMMUNICATIONS INFRASTRUCTURE

(75) Inventor: Bishal Kumar Lachhiramka, Gurgaon (IN)

Correspondence Address: LOUIS VENTRE, JR, 2483 OAKTON HILLS DRIVE, OAKTON, VA, 22124-1530, US

(73) Assignee: DRISHTI-SOFT SOLUTIONS PVT. LTD., Gurgaon (IN)

(21) Appl. No.: 12/015,563

(22) Filed: Jan. 17, 2008

(30) Foreign Application Priority Data
Sep. 5, 2007 (IN) PFF/15/2007/4743

(51) Int. Cl. H04M 3/42

(52) U.S. Cl. 379/214.01

(57) ABSTRACT

A method and a system for providing secretarial services through an intelligent system, which is composed of computers and human operators, in conjunction with a communication infrastructure. The system provides call-handling service to a user as a value added service where an incoming call can be routed to various destinations based on the caller specific preferences set by the user.

### CROSS-REFERENCE TO RELATED APPLICATIONS

The present invention claims the benefit of the filing date of India application PFF/15/2007/4743 filed 5 Sep. 2007, the entire disclosure of which is incorporated by reference herein.

### FIELD OF INVENTION

The present invention relates to a method and a system for providing secretarial services as a value added service to a user. In particular, the invention relates to a method and a system to provide the secretarial services to the user, through a combination of computer systems, communication infrastructure and human operators.

### BACKGROUND OF THE INVENTION

A personal secretary is a person who performs administrative, personal and other routine tasks for an executive. Secretaries perform duties such as handling calls, taking dictations, typing, computer processing, and scheduling for an executive. Secretaries also help the executive with concierge services like booking hotels, airline tickets and other jobs with an aim to aid their hectic lifestyles. Various services carried out by a secretary are hereinafter referred to as ‘secretarial services.’

The services of the human personal secretaries are usually available during office hours only. Further, non-availability of secretarial services during illness, sabbaticals or leaves of the personal secretary could affect the productivity of the executive. Further, non-availability of the secretary may affect important schedules, appointments, meetings etc. of the executive. This holds true especially for the traveling professionals who need round the clock services of the secretary. Another drawback of the conventional personal secretary is the high cost associated with having a dedicated employee as the personal secretary.

### DESCRIPTION OF PRIOR ART

Attempts have been made to automate different aspects of secretarial services by providing assistance services by a human operator at a contact center. An example of a remote secretary like services is disclosed in U.S. Pat. No. 6,775,371, issued on Aug. 10, 2004; herein incorporated by reference. According to the disclosed method and system of the patent, telephone users desiring directory assistance services are connected via standard telephone procedures to a directory assistance provider, such as an operator. The operator provides concierge services like booking a hotel, flight tickets, and the likes to the caller. However, the services provided by the directory system are not exhaustive. The system offers only concierge service and directory service to the user. The system does not provide personalized services to the users.

Another example of a network accessed personal secretary, disclosed in U.S. Pat. No. 5,771,273 issued Jun., 23, 1998, herein incorporated by reference provides secretarial services by allowing access to a remote personalized secretarial platform. The secretary system permits a wide variety of functions with flexibility, while being easily usable by an individual telephone subscriber. The platform can be accessed whenever the subscriber telephone is off-hook through a voice recognition monitor that monitors the subscriber line and is responsive to a pre-selected utterance of the user to generate an access signal. Thus, services like scheduling appointments, receiving messages etc. can be performed by an intelligent system in response to utterances. However, the network accessed personal secretary does not provide various other secretarial services as described above.

There also exist certain contact center based secretarial service systems, which attempts to provide the secretarial services. However, such systems suffer from certain drawbacks. A caller has to dial up into the contact center to interface with the secretary of a user, while she has to call into separate number to reach the user directly. Thus, existence of multiple phone numbers makes this system inconvenient to use.

The above mentioned systems and services suffer from one or more of the following limitations. The existing systems do not provide secretarial services seamlessly. Further, it is not convenient for the user to avail the secretarial services offered by the existing systems. The users need to identify the service provider to subscribe to their services. Further, apart from paying the regular periodic bills, the users need to manage payments for an additional service provider, if they chose to avail the secretarial services.

From the above-mentioned limitations of the existing systems and methods, it is evident that there is need for a secretary system, which can provide complete range of secretarial services. There is need for a secretary system, which is seamless to use. A caller should not be required to call into separate phone numbers to reach the user directly and through a secretary system. Further, there is a need for secretarial services that the user can easily avail. The services need to be provided as a value added service along with a telecommunication service. The services need to be provided such that the user pays only one bill for telecommunications services as well as secretarial services. Further the services need to be provided through multiple convenient pricing models including monthly tariff based or usage wise pricing models or a combination of the two.

### BRIEF SUMMARY OF THE INVENTION

The invention relates to a method and a system for providing an efficient and personalized solution to manage secretarial services through an intelligent system, composed of computers and human operators, in conjunction with a communication infrastructure. The system is capable of providing secretarial services like managing incoming and out going telephone calls, concierge services, directory services, providing dictation services, task scheduling, contact management service and other secretary services. The services are provided as value added services through the communication infrastructure.

In an embodiment of the invention, the system provides call handling service to a user. The invention provides for the system to be integrated with the communication infrastructure. According to the embodiment, the communication infrastructure provider provides the secretary system as a value added service to the user; for example, a GSM service provider. An incoming call is received by a traffic handler in the virtual secretary system. An application server then processes the received call based on the subscriber's preferences stored in a database within the virtual secretary system. The call can be intelligently routed either directly to the user, a human operator who may act as the personal secretary to the user, any external agent or an interactive voice response system, depending on the preferences set by the user for the caller.

### BRIEF DESCRIPTION OF THE DRAWINGS

Various embodiments of the invention will hereinafter be described in conjunction with the appended drawings provided to illustrate and not to limit the invention, wherein like designations denote like elements, and in which:

FIG. 1 is a schematic representing the environment of the virtual secretary system.

FIG. 2 is a schematic representing a communication infrastructure, in accordance with an embodiment of the invention.

FIG. 3 is a schematic representing the virtual secretary system, in accordance with an embodiment of the invention.

FIG. 4 is a schematic of an application server, in accordance with an embodiment of the invention.

FIG. 5 is a flowchart illustrating a method for handling an incoming communication signal by virtual secretary system, in accordance with an embodiment of the invention.

FIG. 6 is a flowchart illustrating an exemplary method for communicating with virtual secretary.

FIGS. 7A and 7B is a flowchart illustrating an exemplary method for handling the incoming calls.

### DETAILED DESCRIPTION

A method and a system for providing an efficient and personalized solution to manage secretarial services through an intelligent system have been disclosed in the invention. The system is composed of computers and human operators that provide secretarial services in conjunction with a communication infrastructure. All incoming phone calls, mobile messages, e-mail messages or any other communication signals are routed intelligently and automatically to various destinations, based on the preferences set by the receiver of the communication signals. The system is integrated with the service provider's network infrastructure such that all the incoming messages are checked for routing preference within the said service provider's network.

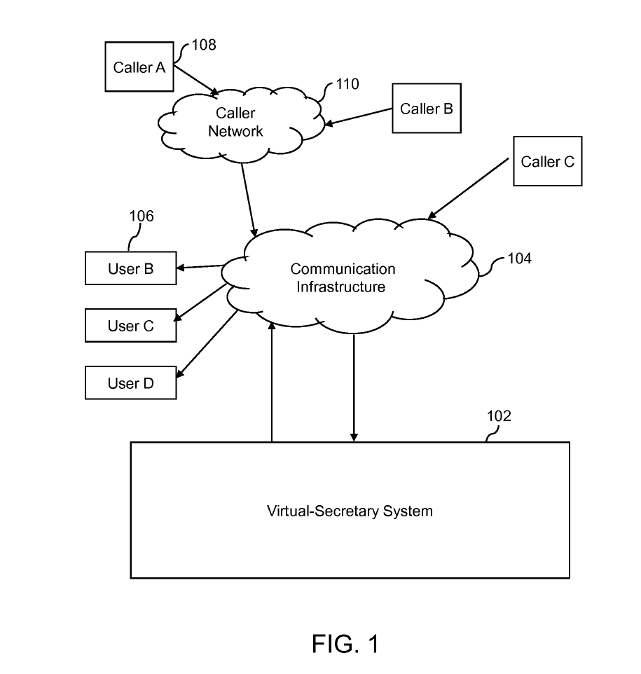

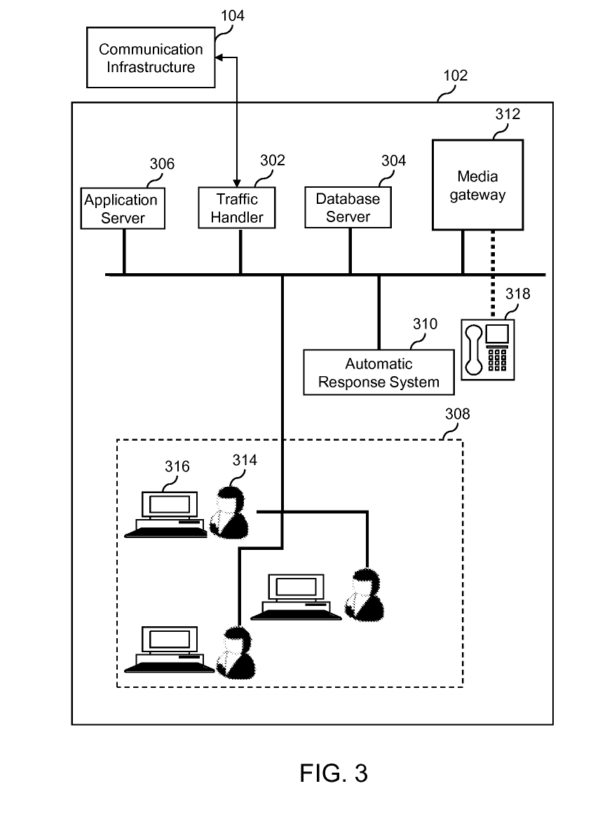

FIG. 1 is a schematic representing the environment of a virtual secretary system 102 in accordance with an embodiment of the invention. The figure illustrates virtual secretary system 102 integrated with a communication infrastructure 104. Virtual secretary system 102 provides call secretarial services to a user 106. The secretary system is a virtual system because secretarial services are provided remotely, and a human agent is not physically present in the same premises as user 106. Further details regarding virtual secretary system 102 have been discussed in conjunction with FIG. 3.

Communication infrastructure 104 is connected to a plurality of callers 108 (directly or via a network, say a caller's network 110) and a plurality of users 106. Communication infrastructure 104 can be a telecom service provider network, a local area network, the Internet or any other communication network. Similarly, caller's network 110 could be a PSTN (Public Switched Telephone Network), mobile network like a GSM or a CDMA network, the Internet or any other communication channel.

According to an embodiment of the invention, communication infrastructure 104 is a PSTN telecom service provider.

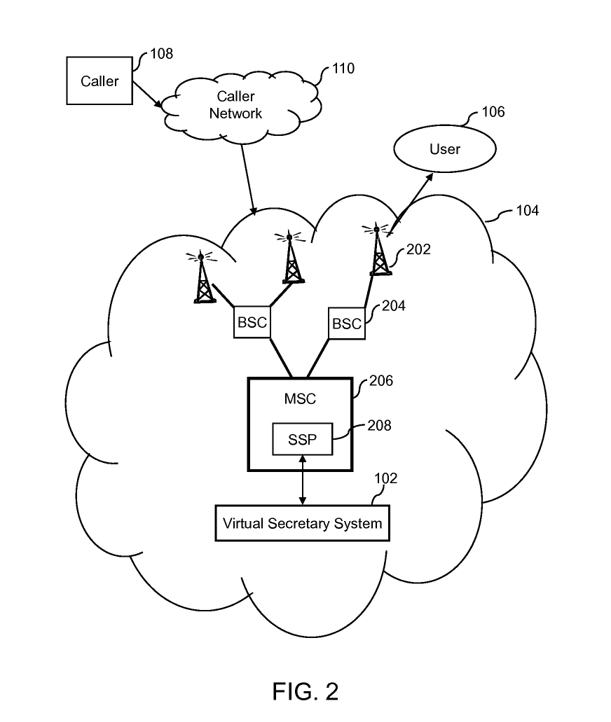

According to another embodiment of the invention, communication infrastructure 104 is a GSM (Global System of Mobile Communication) telecom service provider. In this case, caller A 108 can send SMSs (short message service), voice messages, or may call user B 106 over the GSM telecom service provider 104. Further details regarding GSM telecom service provider 104 have been discussed in conjunction with FIG. 2.

In an alternate embodiment of the invention, communication infrastructure 104 is a CDMA (Code Division Multiple Access) service provider. Similar to the GSM telecom service provider 104, in this case too, caller A 108 can send SMSs (short message service), voice messages or may call user B 106 over the CDMA network.

In an alternate embodiment of the invention, communication infrastructure 104 is an Internet based communication network. Caller A 108 can send in e-mails, messages via chat messengers like Google Talk™, Yahoo Messenger™, ICQ™, Skype™ and other instant messengers or may use IP phone to communicate with user B 106.

In another alternate embodiment of the invention, communication infrastructure 104 is a wireless LAN (local area network) infrastructure.

It would be apparent to a person skilled in the art that caller's network 110 could be any one of the above discussed networks and the invention is not limited to the above mentioned communication infrastructures only.

According to an embodiment of the invention, users 106 are subscribers of communication infrastructure 104 and have subscribed to virtual secretary service provided by communication infrastructure 104. All communication signals from callers 108 send to users 106 are routed through virtual secretary system 102. It will be apparent to a person skilled in the art that a communication signal may be a telephone call, e-mail, chat message, any written correspondence, or any other type of communication signal. Virtual secretary system 102 checks whether user 106 to whom caller 108 sends communication signal has subscribed to the services of virtual secretary system 102 or not. In case user 106 is not a subscriber of the service, the communication signal is directly routed to user 106. However, if user 106 is a subscriber of virtual secretary system 102, the communication signal from a caller may be routed to user 106 in one of the following four ways depending upon the preferences set by user 106 for caller 108. The communication signal can be routed to: 1) a human operator; 2) an IVR system; 3) directly to user 106 or 4) an external agent.

FIG. 2 is a schematic representing communication infrastructure 102 in accordance with an embodiment of the invention. According to the embodiment, communication infrastructure 104 is a GSM (Global System of Mobile Communication) telecom service provider 104. GSM is a digital cellular standard which is the international standard for wireless technology. The GSM standard works in a cellular network. The cellular network is a radio network made up of a number of radio cells (or just cells) each served by a fixed transmitter, known as a base transceiver stations (BTS). The GSM service provider 104 comprises a plurality of BTS (Base Transceiver Stations) 202, a plurality of BSC (Base Station Controllers) 204, and a plurality of MSC (Mobile Switching Centers) 206. A group of BTSs 202 is administered by a BSC 204. Together BTS 202 and BSC 204 systems are known as BSS or Base Station System (BSS). BSC 204 is vital to the BSS system in that it ensures that subscribers can move freely from one cell to another with no loss in signal strength. Further, BSC 204 enables BTS 202 to register mobile phones in a cell, assign control and traffic channels, process call setup and termination. BSC 204 not only manages multiple base stations, but also communicates with a Mobile Switching Center (MSC) 206 to connect individual wireless calls. Mobile Switching Center or MSC 206 is a switching center which is responsible for connecting calls together by switching the digital voice data packets from one network path to another—a process usually called ‘call routing’. MSC 206 forms the heart of the system and performs services like routing calls to and from mobile phones; controlling the set-up and termination of calls; providing data for billing; acting as the link between mobile and the public telephone network. Finally, MSC 206 also controls hand-off between itself and other MSCs.

Virtual secretary system 102 is integrated with GSM telecom service provider 104. According to an embodiment of the invention, the integration is achieved by enabling an intelligent network over MSC 206. An intelligent network is a service-independent telecommunications network, where computer systems are included in the network and applications run on computer systems instead of switches. Intelligent networks are established to provide means for developing and controlling services (for example value added services).

According to an embodiment of the invention, the intelligent network is achieved by implementing a Service Switching Point (SSP) 208 in MSC 206. SSP is a switching system that provides end users with access to the telecommunications network and provides necessary switching functionalities. SSP also allows users to access the set of services provided by the intelligent network.

Virtual secretary system 102 is connected to SSP 208 as an intelligent peripheral of the intelligent network. The virtual secretary service is configured in a Service Control Point (SCP). SCP provides control for the value added services provided by virtual secretary system 102. Virtual secretary system 102 may be tightly integrated to communications infrastructure 104, and exist within communications infrastructure 104. Alternatively, virtual secretary system 102 may be loosely integrated to communications infrastructure 104 and may exist outside communications infrastructure 104.

When caller 108 makes a call to user 106, the call is first routed to BTS 202. The call is then routed to BSC 204. BSC 204 passes the call to MSC 206. The call is then routed to virtual secretary system 102. According to an embodiment of the invention, virtual secretary service is provided as a value added service to the subscribers of communications network 104. The value added service may be provided in multiple packages for the subscribers to choose from. For example, the service provider can offer a monthly tariff based or a usage wise charging model or a combination thereof. Service provider can also offer the virtual secretary value added service free of cost to its subscribers for indirect benefits or in combination with some other services.

FIG. 3 is a schematic representing virtual secretary system 102 in accordance with an embodiment of the invention. Virtual secretary system 102 consists of a traffic handler 302 to handle communication signals, a database 304 for storing data related to callers 108 and users 106, an application server 306 for analyzing the data and deciding the routing path of the communication signal, human operators 314 for providing secretarial service to user 106 and an automated response system 310 which is a programmable device to respond to the communication signal. Virtual secretary system 102 further consists of a media gateway 312 for converting digital communication signals into analog signals. Media gateway 312 allows the use of existing analog phones to receive digital telecommunication signals. The digital telecommunication signals may be, for example, VoIP (Voice Over Internet Protocol) signals.

Communication signal from communication infrastructure 104 is routed to a traffic handler 302 in virtual secretary system 102. Traffic handler 302 could be a hardware or a software based switch or router for handling the incoming communication signals. Therefore, traffic handler 302 acts as a gateway for the incoming communication signal. Traffic handler 302 receives communication signals of various media types and re-routes the outgoing communication from virtual secretary system 102 to mobile switching center 206 in communication infrastructure 104 for further routing.

Traffic handler 302 transmits the incoming communication signal to one or more application servers 306. Application server 306 is a server computer in virtual secretary system 102 dedicated to running certain software applications. Application server 306 retrieves and processes user information from database 304. In an embodiment of the invention, application server 306 processes the user information based on preferences set for user 106. The media type of the incoming message decides the path of the communication signal and the preferences set for caller 108 by user 106. In an embodiment of the invention application server 306 can be an IBM p5-560Q Express server, HP 9000 server, or a Xeon dedicated virtual server. Application server 306 is interconnected to one or more databases 304, which manages and stores user and caller data. The user data comprises user names, user's presence information, contact numbers, email addresses, chat ids, call histories containing threads of past communications, personal information regarding appointments, schedules and other documents in computer readable form. Further, associated with each user 106, database 304 maintains a caller data for each contact in the address book of user 106. The caller data comprises of caller name, phone and mobile numbers, email addresses, chat ids, relationship with respect to user 106, the corresponding communication signal handling preferences and the routing rules. It would be apparent to a person skilled in the art that database 304 is capable of storing any type of suitable information, and is not limited to the above-mentioned user and caller data. In an embodiment of the invention the database 304 could be a Sun Fire X4500 server, IBM DB2 9 data server, an Oracle Database 10 g server or any other database server.

The traffic handler 302 routes the communication signal depending on the path determined by application server 306. In the preferred embodiment of the invention, communication signal could be routed to a contact center 308, an automatic response system 310, directly to user 106 or an external agent who may be a contact in the address book of user 106 or any other number.

Contact center 308 is a functional area within communication infrastructure 104 or an outsourced, separate facility which exists solely to answer inbound or place outbound telephone calls, handle incoming SMS, emails, answer chat messages and perform other secretarial services. It is capable of providing personal secretary services, directory assistance, multilingual user support, inbound and outbound telemarketing, and web-based services. In an embodiment of the invention, human operators 314 are a part of a contact center 308. It will be apparent that different human operators 314 may also exist at different locations. Human operator 314 is equipped with communication interface 316 to enable human operators 314 handle incoming communication signals of various media types. Communication interface 316 helps in communicating between human operator 314 in contact center 308 with user 106 and caller 108. Communication interface 316 may comprise computer, telephone headphone, speaker, microphone, fax machine and other devices for communication. Human operator 314 acts as a personal secretary for user 106 and provides secretarial and call handling services to user 106.

According to an embodiment of the invention, virtual secretary system 102 is directly connected to multiple human operators in different locations. Alternatively, virtual secretary system 102 may also be connected to automated systems for appropriate responses.

In an embodiment of the invention, caller A 108 sends a communication signal to user B 106. If the preference for caller A 108 stored in data server 304 is such that all calls from caller A 108 must first be attended by a personal secretary then, traffic handler 302 routes the call to human operator 314. Human operator 314, who acts as a personal secretary, responds to the call suitably. Caller 106 is identified by her unique identification information in the incoming communication signal. In case the communication is through a phone call, the unique identification information is a phone number of caller 108. Communication interface 316 displays user information as well as caller information to human operator 314. The user information may include a phone number, name, last communication threads with caller 108, and the preferences set for caller 108. Caller information comprises caller name, phone number, and other such details. This enables human operator 314 to link caller's 108 last interactions to user 106. In an alternate embodiment of the invention, caller A 108 sends an email to user B 106. If the preferences for caller A 108 are such that the email is first routed to the secretary, human operator 314 appropriately replies to the email received. Here e-mail id of caller 108 is unique identification information. Human operator 314 either may reply herself or may forward the email to user 106 with appropriate follow up.

In an embodiment of the invention, user 106 can use services other than call handling services of virtual secretary system 102. User 106 can send a request message to human operator 314 for a secretary service. User 106, for example, can call contact center 308, send an email message, send a request through SMS, or send a request through chat. The request message can be for updating personal calendar of user 106, scheduling meetings with an external agent, booking a flight ticket, giving dictations or calling another person. In another embodiment of the invention, user 106 can configure and delegate reminders and callbacks for events and tasks. For example, user 106's friend birthday could be reminded in advance so that user 106 is able to plan his schedule in advance. The reminder/call-backs are notified to user 106 by human operator 314 through phone calls, SMS, emails, chat messengers or other means of communication. In an alternate embodiment of the invention, user 106 may schedule reminders with virtual secretary system 102, either through a web interface or with the help of human operator 314. For example, user 106 may schedule a meeting with a client or any external agent. This information can be communicated to human operator 314 either through a SMS, a phone call, an email, a chat message or through any other communication means. Human operator 314 or automated response system 312 may call up user 108 at the scheduled time. Human operator 314 is capable of providing other secretarial services like concierge services, directory services and dictation services. It would be apparent to a person skilled in the art, that the services may not be limited to abovementioned services and that all kinds of secretary services can be provided by human operator 314.

In an embodiment of the invention, the user preferences for virtual secretary 102 may, at anytime, be configured by user 106. User 106 may define privileged access to other co-configurators to configure virtual secretary 102. For instance, user 106 and a co-configurator may be a supervisor and an employee respectively. The supervisor may subscribe to the virtual secretary service and provide access to the service to the employee with limited privileges. The supervisor may keep the privilege of defining groups and allow multiple employees to set their respective properties like receiving the calls directly or receiving it only after the verification by human operator 314. It would be apparent that there may be any number of co-configurators and the number of co-configurators may be limited by service provider 104. Further, user 106 may define properties for a group of employees rather defining properties individually. The supervisor may choose to allow its employees to configure certain preferences or to configure none at all.

In an embodiment of the invention user 106 is allowed to configure a plurality of profiles. Each profile is activated at different times as per the choice of user 106. For instance, user 106 may choose a roaming profile when roaming out of the service provider's local area. The roaming profile may allow only certain incoming calls as allowed by user 106, to be received by user 106. It would be apparent that the number of profiles may be limited by service provider 104.

The communication signal from caller 108 is routed to virtual secretary system 102 from MSC 206. The communication signal is then, further routed to human operator 314 situated in contact center 308. In an embodiment of the invention, contact center 308 is integrated with the existing communication infrastructure 104. The integration is achieved by directly connecting virtual secretary system 102 to MSC 206. User 106 is connected to a node of communication infrastructure 104 unlike virtual secretary system 102. A node of a communication infrastructure is typically, for example, a mobile device, which is connected wirelessly to BTS 202. This enables communication infrastructure 104 provider the advantage of providing the secretary service as a value added service along with the communication service to user 106.

The other destination where the communication signal can be routed in case of a call is automatic response system 310. Automatic response system 310 can be programmed to answer the call. Automatic response system 310 can be programmed to give a busy tone to caller 108 depending upon the preference set for caller 108. In an embodiment of the invention, automatic response system 310 is an IVR (Interactive Voice Response) system, which can interactively guide caller 108 for entering her personal details and messages for user 106.

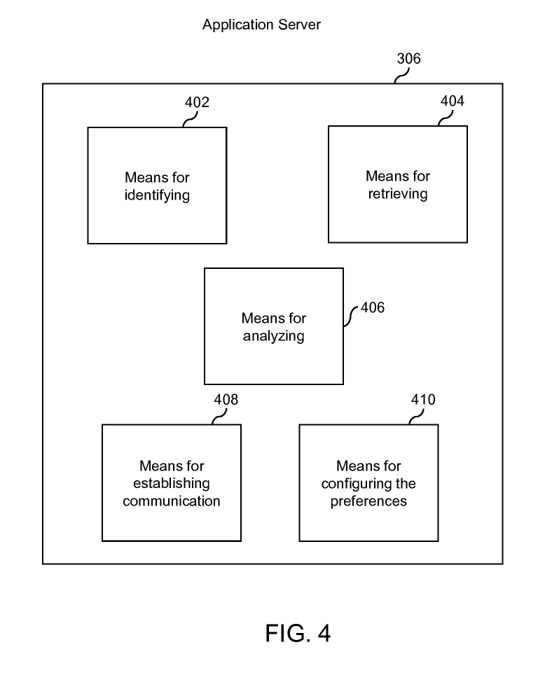

FIG. 4 is a schematic of application server 306 in accordance with an embodiment of the invention. Application server 306 consists of a means for identifying 402 that enables application server to identify user 106 and caller 108. When a communication signal is received by traffic handler 302, means for identifying 402 in application server 306 identifies caller 108 and user 106, using unique identification information as discussed in conjunction with FIG. 3. A means for retrieving 404 in application server 306 retrieves the caller and user information from database 304. Further, a means for analyzing 406 processes the retrieved caller and user information and based on the preferences set for caller 108, determines the path for routing the communication signal, as discussed above in conjunction with FIG. 3.

Application server 306 further comprises a means for establishing communication 408 between human operator 314 and user 106. Means for establishing communication 408 connects the incoming communication signal to the appropriate answering device. Means for establishing communication 408 is also capable of sending a communication signal to users 106 and callers 108. In an embodiment of the invention, human operator 314 generates a message for an event, for example, setting up a meeting between various callers 108 and user 106. The event may be triggered either by a request from caller 108, user 106 or human operator 314. The event may also be triggered automatically under certain circumstances.

Application server 306 further comprises a means for configuring the preferences 410 to modify specific user preferences. The user preferences can be added, updated and altered by means for configuring the preferences 410. Means for configuring the preferences may be accessed by user 106 or human operator 314.

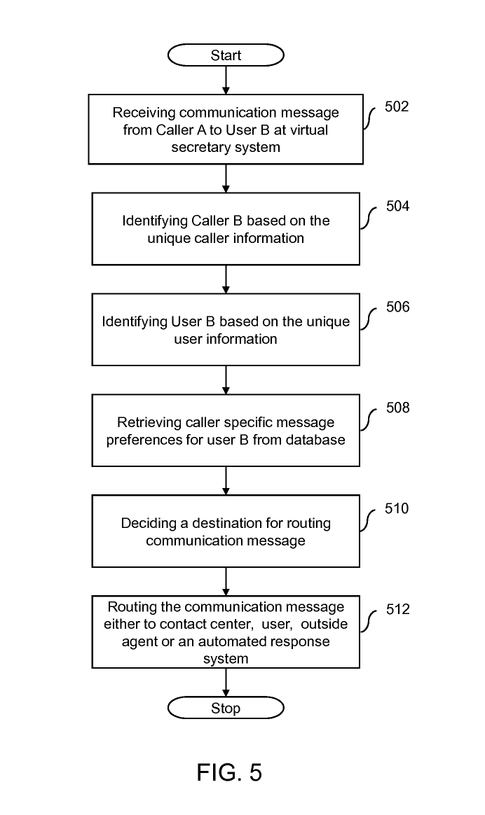

FIG. 5 is a flowchart illustrating the method steps for handling an incoming communication signal by virtual secretary system 102. At step 502, a communication signal from caller A 108 to user B 106 is received by virtual secretary system 102. At step 504, caller B is identified based on the unique caller information. At step 506, user B is identified based on the unique user information. At step 508, caller specific message preferences, user information and caller information are retrieved from database 304. At step 510, the retrieved caller and user information is analyzed and the destination for routing of the call is determined. At step 512, the communication signal is routed, depending upon the determined destination for routing, either to human operator 314, automatic response system 310, user B 106 or an external agent who may be a contact in the address book of user 106 or any other number.

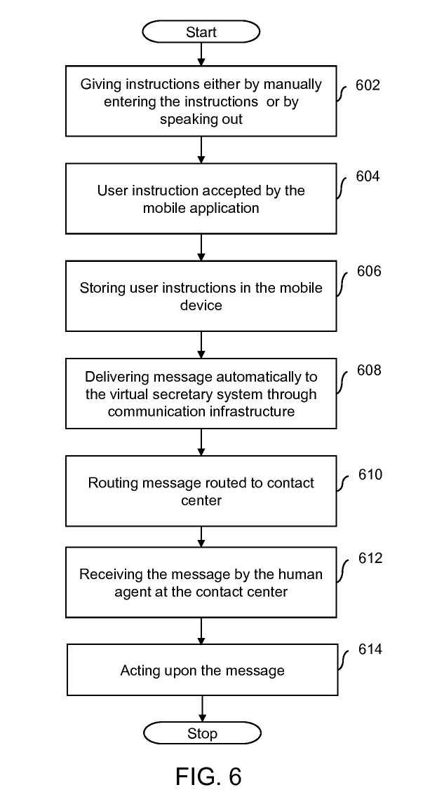

FIG. 6 is a flowchart illustrating an exemplary method for communicating with virtual secretary system 102 where user uses a mobile phone to transmit instructions, in an embodiment of the invention. At step 602, user 106 provides instructions for the secretarial services on her mobile phone. The instructions may, for example, be for scheduling a meeting with an external agent, booking a flight ticket, updating personal calendar, giving dictations or calling another person. At step 604, the instructions given by user 106 are entered in the mobile device. The instructions can be provided through an SMS, voice instructions, or through phone key instructions. An intelligent mobile software application, installed on the mobile device, can be used for receiving instructions from user 106. The mobile software application may be a Java software based on Symbian™, Windows Mobile™, or other operating systems. The intelligent mobile software application provides interface to use and configure virtual secretarial system 102. The intelligent mobile software application synchronizes the contact list, events, reminders, calendar of the mobile device with virtual secretary system 102. The intelligent mobile software application may also facilitate user 106 to communicate with virtual secretary system 102 for provisioning of certain services. At step 606, these instructions are stored into the mobile. Subsequently, at step 608, these instructions are transmitted automatically over communication infrastructure 104 (mobile network) to virtual secretary system 102. The intelligent mobile software application may use SMS, GPRS (General Packet Radio Service), or data call to synchronize information/data with virtual secretary system 102. At step 610, the message is routed to contact center 308. At step 612, human operator 314 at contact center 308 receives the message. Communication interface 316 displays the message to human operator 314. Subsequently, at step 614 human operator 314 suitably responds to the message. Human operator 314 may update the calendar, update the user's scheduler, fix an appointment with an external agent, call or write an email to an external agent, book a flight ticket or may even take a dictation.

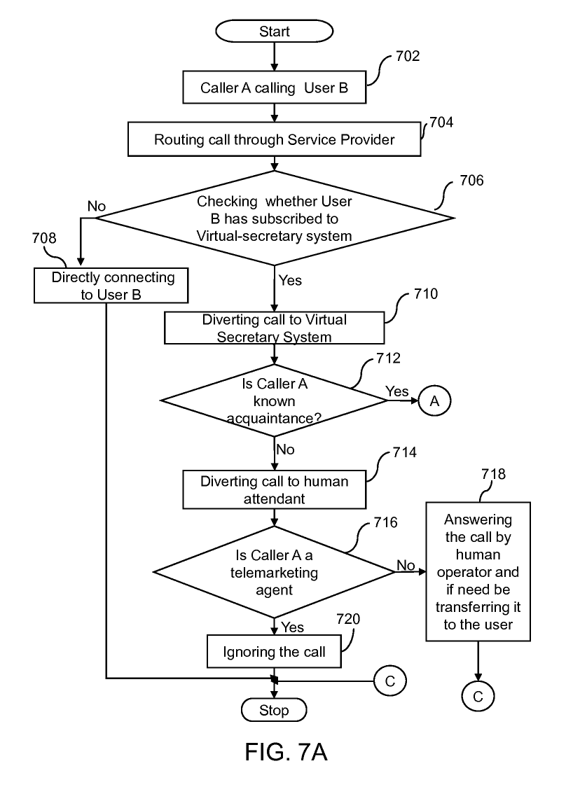

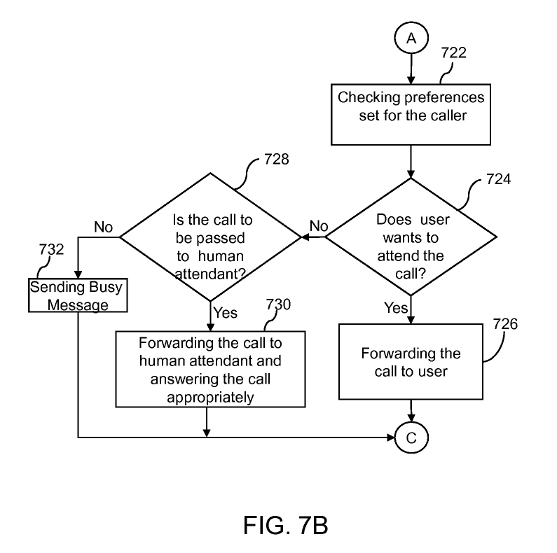

FIGS. 7A and 7B is a flowchart illustrating an exemplary method for handling incoming calls, in accordance with an embodiment of the invention. In the example, the caller specific message preference for user B 106 is set such that any call not from an acquaintance of user B 106, is routed to a human attendant. Further, any call by a telemarketing agent is ignored.

At step 702 caller A 108 calls user B 106. At step 704, the call is routed through communication infrastructure 104. Thereafter at step 706, a check is made to confirm if user B 106 has subscribed to virtual secretary service. If user B 108 has subscribed to virtual secretary service, step 710 is executed, otherwise step 708 is executed. At step 708, the call is routed directly to user B 108. At step 710, the call is routed to virtual secretary system 102. Subsequent to step 710, at step 712, virtual secretary system 102 checks whether caller A 108 is a known acquaintance to user B 106 or not. If caller A 108 is a known acquaintance to user B 106, then step 722 is executed, otherwise step 714 is executed. At step 714, the call is routed to a human operator 314. Thereafter at step 716, human operator 314 identifies if the call is from a telemarketing agent. If the call is from a telemarketing agent, then step 720 is executed, otherwise step 718 is executed. At step 718, human operator 314 answers the call, and if need be, transfers the call to user B 106. At step 720, the call is ignored.

At step 722, the preferences set by user B 106 for caller A 108 are recalled. Thereafter at step 724, user B's 106 preference for attending caller A's 108 call is checked. If the preferences indicate that the call is to be attended by user B 106, step 726 is executed, otherwise step 728 is executed. At step 726, the call is forwarded to user B 106, who attends the call. At step 728, preference setting for attending the call by human operator 314 is checked. If the user preferences indicate that the call is to be attended by human operator 314, step 730 is executed, otherwise step 732 is executed. At step 730, the call is routed to human operator 314. At step 732, caller A 108 is responded to with a busy tone.

What is claimed is:

1. A system for handling an incoming communication signal to a user from a caller, the incoming communication signal being delivered through a communication infrastructure, the communication infrastructure being integrated with the system and a contact center, the system comprising:
(a) means for identifying the user, based on unique user identification information in the incoming communication signal;
(b) means for identifying the caller, based on unique caller identification information in the incoming communication signal;
(c) a database, the database for storing caller specific message handling preferences for the user; and,
(d) means for routing the incoming communication signal to a destination, based on the retrieved caller specific message handling preferences, the destination being selected from an automated response system, an external agent, the user and the contact center.

2. The system as recited in claim 1 wherein the communication infrastructure is a telecommunication service provider network.

3. The system as recited in claim 1 wherein the communication signal is a telephone call.

4. The system as recited in claim 2 wherein the user is a subscriber of the telecommunication service provider network.

5. The system as recited in claim 1, further comprising means for retrieving the caller specific message handling preferences from the database.

6. The system as recited in claim 1 wherein the contact center further comprises at least one human operator.

7. The system as recited in claim 1, further comprising means for configuring the message handling preferences.

8. The system as recited in claim 1 wherein the automated response system is capable of responding with signal like a busy tone.

9. A system for providing secretarial services to a user, the user being capable of sending and receiving communication signal through a communication infrastructure, the communication infrastructure being integrated with the system and a contact center, the contact center comprising at least one human operator, the system comprising:
(a) a database, the database storing user data;
(b) means for retrieving user data from the database;
(c) an automated system for providing secretarial services to the user; and,
(d) means for establishing communication through the communication infrastructure between the user and a human operator in the contact center, wherein the human operator is capable of providing secretarial services to the user based on the user data.

10. The system as recited in claim 9, database further comprising means for storing user data into the database.

11. The system as recited in claim 9, database further comprising means for updating user data in the database.

12. The system as recited in claim 9, wherein the communication infrastructure is a telecommunication service provider network.

13. The system as recited in claim 9, wherein the communication signal is a telephone call.

14. The system as recited in claim 9, wherein the communication signal is a short message service message.

15. The system as recited in claim 9, wherein the communication signal is an email.

16. The system as recited in claim 9, wherein the user data comprise user's presence information, user's contact list information, user's calendar information, and user's preference information.

17. The system as recited in claim 9, further comprising a mobile application for generating secretarial service request messages.

18. A computer implemented method for handling an incoming communication signal to a user from a caller, the incoming communication signal being delivered through a communication infrastructure, the communication infrastructure being integrated with a contact center, the method comprising:
(a) identifying the user, based on unique user identification information in the incoming communication signal;
(b) identifying the caller, based on unique caller identification information in the incoming communication signal;
(c) retrieving caller specific message handling preferences for the user from a database; and,
(d) routing the incoming communication signal to a destination, based on the retrieved caller specific message handling preferences, the destination being selected from an automated response system, an external agent, the user and the contact center.

19. The method as recited in claim 18, further comprising answering the incoming communication signal by a human operator.

20. The method as recited in claim 18, wherein the communication infrastructure is a telecommunication service provider network.

21. The method as recited in claim 18, further comprising configuring the call handling preferences.

22. A computer implemented method for providing secretarial services to a user, the user being capable of sending request messages for secretarial services through a communication infrastructure, the communication infrastructure being integrated with the system and a contact center, the contact center comprising at least one human operator, the method comprising:
(a) receiving a request message for a secretarial service from the user;
(b) identifying the user, based on unique user identification information in the request message;
(c) storing user data into a database;
(d) retrieving user data from the database; and,
(e) routing the request message to the contact center, wherein the human operator in the contact center is capable of servicing the request message.

23. A computer program product for use with a computer, the computer program product comprising a computer usable medium having a computer readable program code embodied therein for handling an incoming communication signal to a user from a caller, the incoming communication signal being delivered through a communication infrastructure, the communication infrastructure being integrated with a contact center, the computer program code performing:
(a) identifying the user, based on unique user identification information in the incoming communication signal;
(b) identifying the caller, based on unique caller identification information in the incoming communication signal;
(c) retrieving caller specific message handling preferences for the user from a database; and,
(d) routing the incoming communication signal to a destination, based on the retrieved caller specific message handling preferences, the destination being selected from an automated response system, an external agent, the user and the contact center.

24. The computer program product as recited in claim 23, further performing answering the incoming communication signal by a human operator.

25. The computer program product as recited in claim 23, wherein the communication infrastructure is a telecommunication service provider network.
